(19) United States
(12) Patent Application Publication
(10) Pub. No.: US 2015/0286311 A1
(43) Pub. Date: Oct. 8, 2015

(54) PASSIVE TOUCH PEN

(71) Applicants: A-Ming Chang, Taipei (TW); Ying-Che Tseng, Taipei (TW)

(72) Inventors: A-Ming Chang, Taipei (TW); Ying-Che Tseng, Taipei (TW)

(73) Assignee: Primax Electronics Ltd., Taipei (TW)

(21) Appl. No.: 14/335,620

(22) Filed: Jul. 18, 2014

(30) Foreign Application Priority Data
Apr. 3, 2014 (CN) 201420160735.6

(51) Int. Cl. G06F 3/044; G06F 3/0354

(52) U.S. Cl. CPC G06F 3/044; G06F 3/03545

(57) ABSTRACT

A passive touch pen for a capacitive touch screen is provided. The passive touch pen includes a first pen tube, a second pen tube, a conductive rubber tip, a switch member, a circuit board, a positive electrode part, a conductive plate, and a battery. The switch member includes a rotary element, a first conductive element, a second conductive element, and a negative electrode part. While the second conductive element is correspondingly rotated with the rotary element to be contacted with the negative electrode part, a conductive loop is defined by a negative trace, the conductive plate, the first pen tube, the first conductive element, the second conductive element, the negative electrode part, the battery, the positive electrode part and a positive trace collaboratively. Through the switch member, the function of providing electric power of a battery can be easily achieved. Consequently, the power-saving efficacy is enhanced.

### FIELD OF THE INVENTION

The present invention relates to a touch pen, and more particularly to a passive touch pen for a capacitive touch screen.

### BACKGROUND OF THE INVENTION

Nowadays, the commercially available touch screens are classified into several types, including a resistive touch screen, an acoustic wave touch screen, an infrared touch screen and a capacitive touch screen. When an external force is exerted on the resistive touch screen, a voltage is generated and a command is recognized according to the voltage. Moreover, acoustic waves or infrared rays pass over the surface of the acoustic wave touch screen or the infrared touch screen. By touching the surface of the acoustic wave touch screen or the infrared touch screen, the travelling path of the acoustic wave or the infrared ray is blocked and thus the corresponding command is recognized. When the capacitive touch screen is contacted with the human body, the capacitance value of the touch panel is subjected to a change because of the static electricity of the human body. According to the change of the capacitance value, the touch position is recognized. In views of the touch accuracy and the fabricating cost, the capacitive touch screen is widely adopted.

For complying with the utilized function of the capacitive touch screen, a capacitive touch pen is introduced into the market. Generally, the capacitive touch pen is used for tapping or selecting the capacitive touch screen. In addition, the capacitive touch pen may also have the handwriting and drawing functions. In accordance with the current technology, the capacitive touch pens are classified into two types, i.e. active touch pens and passive touch pens. The passive touch pen has a contact tip made of a conductive rubber. Moreover, the conductive rubber tip is combined with a metallic pen tube. When the conductive rubber tip touches the capacitive touch screen, a loop is defined by the passive touch pen and the human body. Consequently, the capacitance value of the capacitive touch screen is subjected to a change because of the static electricity of the human body. However, the conventional passive touch pen does not have the function of sensing the pen pressure. Consequently, when the passive touch pen is used in handwriting and drawing, the line thickness fails to be changed in response to the force exerted by the user. Moreover, the conventional passive touch pen does not have a left button function, a right button function, a multi-touch function and other general functions. In other words, the conventional passive touch pen is not user-friendly.

For achieving the function of sensing the pen pressure, a pressure sensor may be installed in the pen tube to sense the pressure that is exerted on the conductive rubber tip, and the pressure sensor may send a corresponding signal to the capacitive touch screen to control the line thickness shown on the display screen. Similarly, corresponding electronic switches may be installed in the pen tube in order to achieve the left button function, the right button function, the multi-touch function and other general functions. Nowadays, in views of easy portability and aesthetics, the general trends in designing passive touch pens are toward small size and light weightiness. In other words, the size and capacity of the battery that is placed within the pen tube for powering the pressure sensor or the electronic switch will be restricted. Under this circumstance, it is important to extend the use time of the battery.

### SUMMARY OF THE INVENTION

An object of the present invention provides a passive touch pen capable of easily enabling or disabling the function of providing electric power of a battery, thereby achieving power-saving efficacy.

In accordance with a first aspect of the present invention, there is provided a passive touch pen for a capacitive touch screen. The passive touch pen includes a first pen tube, a second pen tube, a conductive rubber tip, a switch member, a circuit board, a positive electrode part, a conductive plate, and a battery. The first pen tube is made of a conductive material. The second pen tube is connected with a front end of the first pen tube. The conductive rubber tip is connected with the second pen tube. The switch member is located at a distal end of the first pen tube. A function of providing electric power of the battery is selectively enabled or disabled through the switch member. The switch member includes a rotary element, a first conductive element, a second conductive element, and a negative electrode part. The rotary element includes a pillar part and a rotating block. The pillar part is inserted into the first pen tube. The rotating block is exposed outside the first pen tube. The first conductive element is sheathed around the pillar part and connected with an inner wall of the first pen tube. The second conductive element is sheathed around the pillar part and contacted with the first conductive element, and includes a protrusion part. The negative electrode part is fixed in the first pen tube and located near the protrusion part of the second conductive element. While the rotating block is rotated, the second conductive element is correspondingly rotated with the pillar part, so that the protrusion part is contacted with or separated from the negative electrode part. The circuit board is disposed within the second pen tube. The positive electrode part is connected with a positive trace of the circuit board. The conductive plate is connected with a negative trace of the circuit board, and contacted with the inner wall of the first pen tube. The battery is disposed within the first pen tube. A negative terminal and a positive terminal of the battery are contacted with the negative electrode part and the positive electrode part, respectively. When the protrusion part of the second conductive element is contacted with the negative electrode part, a conductive loop is defined by the negative trace, the conductive plate, the first pen tube, the first conductive element, the second conductive element, the negative electrode part, the battery, the positive electrode part and the positive trace collaboratively, so that the battery provides the electric power to the circuit board.

In accordance with a second aspect of the present invention, there is provided a passive touch pen for a capacitive touch screen. The passive touch pen includes a first pen tube, a second pen tube, a conductive rubber tip, a switch member, a circuit board, a positive electrode part, a conductive plate, a connecting element, and a battery. The first pen tube is made of a conductive material. The second pen tube is connected with a front end of the first pen tube. The conductive rubber tip is connected with the second pen tube. The switch member is located at a distal end of the first pen tube. A function of providing electric power of the battery is selectively enabled or disabled through the switch member. The switch member includes a push switch, a first conductive element, a second conductive element, and a negative electrode part. The push switch includes a first pin, a second pin and a triggering part. The first conductive element is connected with the first pin. The second conductive element is connected with the second pin. The negative electrode part is connected with the second conductive element. The circuit board is disposed within the second pen tube. The positive electrode part is connected with a positive trace of the circuit board. The conductive plate is connected with a negative trace of the circuit board. The connecting element is connected with the first conductive element and the conductive plate. The battery is disposed within the first pen tube. A negative terminal and a positive terminal of the battery are contacted with the negative electrode part and the positive electrode part, respectively. When the triggering part is pressed and the first pin and the second pin are electrically connected with each other, a conductive loop is defined by the negative electrode part, the second conductive element, the second pin, the first pin, the first conductive element, the connecting element, the conductive plate, the negative trace, the battery, the positive electrode part and the positive trace collaboratively, so that the battery provides the electric power to the circuit board.

In accordance with a third aspect of the present invention, there is provided a passive touch pen for a capacitive touch screen. The passive touch pen includes a first pen tube, a second pen tube, a conductive rubber tip, a pen clip, a negative electrode part, a circuit board, a positive electrode part, a conductive plate, a push switch, and a battery. The first pen tube is made of a conductive material. The second pen tube is connected with the first pen tube. The conductive rubber tip is connected with the second pen tube. The pen clip is connected with a lateral surface of the first pen tube, and includes a first end and a second end. The first end and the second end are in parallel with each other. The first end is exposed outside the first pen tube. The second end is disposed within the first pen tube. The negative electrode part is disposed within the first pen tube, and connected with an inner wall of the first pen tube. The circuit board is disposed within the second pen tube. The positive electrode part is connected with a positive trace of the circuit board. The conductive plate is connected with a negative trace of the circuit board, and contacted with the inner wall of the first pen tube. The push switch is disposed on the circuit board, and includes a triggering part. A function of providing electric power of a battery is selectively enabled or disabled through the push switch. The battery is disposed within the first pen tube. A negative terminal and a positive terminal of the battery are contacted with the negative electrode part and the positive electrode part, respectively. When the first end of the pen clip is pushed and the pen clip is moved along the first pen tube, the push switch is pressed by the second end of the pen clip, so that the push switch is turned on, wherein after the push switch is turned on, a conductive loop is defined by the positive trace, the positive electrode part, the battery, the negative electrode part, the first pen tube, the conductive plate and the negative trace, so that the battery provides the electric power to the circuit board.

In accordance with a fourth aspect of the present invention, there is provided a passive touch pen for a capacitive touch screen. The passive touch pen includes a first pen tube, a second pen tube, a conductive rubber tip, a pen clip, a negative electrode part, a circuit board, a positive electrode part, an elastic conductive element, and a battery. The first pen tube is made of a conductive material. The second pen tube is connected with the first pen tube. The conductive rubber tip is connected with the second pen tube. The pen clip is made of a conductive material, and connected with a lateral surface of the first pen tube. The negative electrode part is disposed within the first pen tube, and connected with an inner wall of the first pen tube. The circuit board is disposed within the second pen tube. The positive electrode part is connected with a positive trace of the circuit board. The elastic conductive element is connected with a negative trace of the circuit board. A function of providing electric power of the battery is selectively enabled or disabled through the elastic conductive element. The battery is disposed within the first pen tube. A negative terminal and a positive terminal of the battery are contacted with the negative electrode part and the positive electrode part, respectively. When the elastic conductive element is connected with the pen clip, a conductive loop is defined by the negative electrode part, the first pen tube, the pen clip, the elastic conductive element, the negative trace, the battery, the positive electrode part and the positive trace collaboratively, so that the battery provides the electric power to the circuit board.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a passive touch pen according to a first embodiment of the present invention;

FIG. 2 is a schematic exploded view illustrating the switch member of the passive touch pen according to the first embodiment of the present invention;

FIG. 3 is a schematic perspective view illustrating a hollow fixing post of the passive touch pen according to the first embodiment of the present invention and taken along a first viewpoint;

FIG. 4 is a schematic perspective view illustrating the hollow fixing post of the passive touch pen according to the first embodiment of the present invention and taken along a second viewpoint;

FIG. 5 is a schematic assembled view illustrating the switch member of the passive touch pen according to the first embodiment of the present invention;

FIG. 6 is a schematic assembled view illustrating the combination of the second pen tube, a circuit board, a positive electrode part and a conductive plate of the passive touch pen according to the first embodiment of the present invention;

FIG. 7 is a schematic exploded view illustrating the combination of the second pen tube, the circuit board, the positive electrode part and the conductive plate of the passive touch pen according to the first embodiment of the present invention;

FIG. 8 is a schematic cutaway view illustrating the passive touch pen according to the first embodiment of the present invention;

FIG. 9 is a schematic cross-sectional view illustrating a passive touch pen according to a second embodiment of the present invention;

FIG. 10 is a schematic cross-sectional view illustrating a passive touch pen according to a third embodiment of the present invention;

FIG. 11 is a schematic cross-sectional view illustrating a passive touch pen according to a fourth embodiment of the present invention;

FIG. 12 is a schematic cross-sectional view illustrating a passive touch pen according to a fifth embodiment of the present invention; and

FIG. 13 is a schematic cross-sectional view illustrating a passive touch pen according to a sixth embodiment of the present invention.

### DETAILED DESCRIPTION OF THE PREFERRED EMBODIMENT

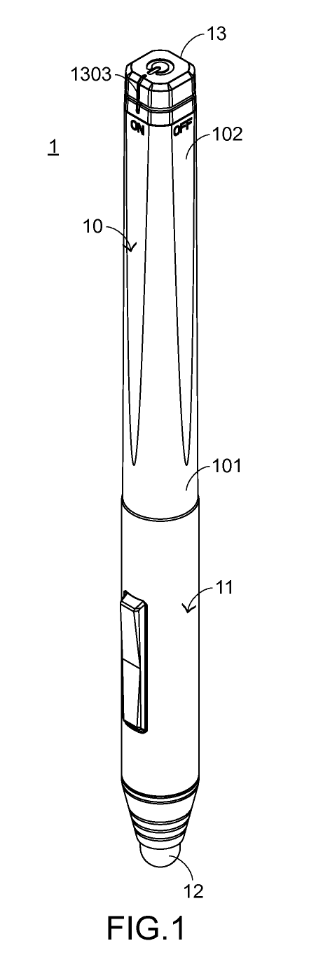

Hereinafter, a passive touch pen according to a first embodiment of the present invention will be illustrated with reference to FIG. 1. FIG. 1 is a schematic perspective view illustrating a passive touch pen according to a first embodiment of the present invention.

As shown in FIG. 1, the passive touch pen 1 of this embodiment comprises a first pen tube 10, a second pen tube 11, a conductive rubber tip 12, and a switch member 13. The two ends of the second pen tube 11 are connected with a front end 101 of the first pen tube 10 and the conductive rubber tip 12, respectively. The switch member 13 is located at a distal end 102 of the first pen tube 10. By grasping the first pen tube 10 or the second pen tube 11, the user may operate the conductive rubber tip 12 to control a capacitive touch screen. Moreover, by means of the switch member 13, additional functions may be selectively enabled or disabled. The additional functions will be illustrated later. In this embodiment, the additional functions include the function of sensing the pen pressure sensing function or the function of executing a specified application program (e.g. a left button function, a right button function, a multi-touch function and the like).

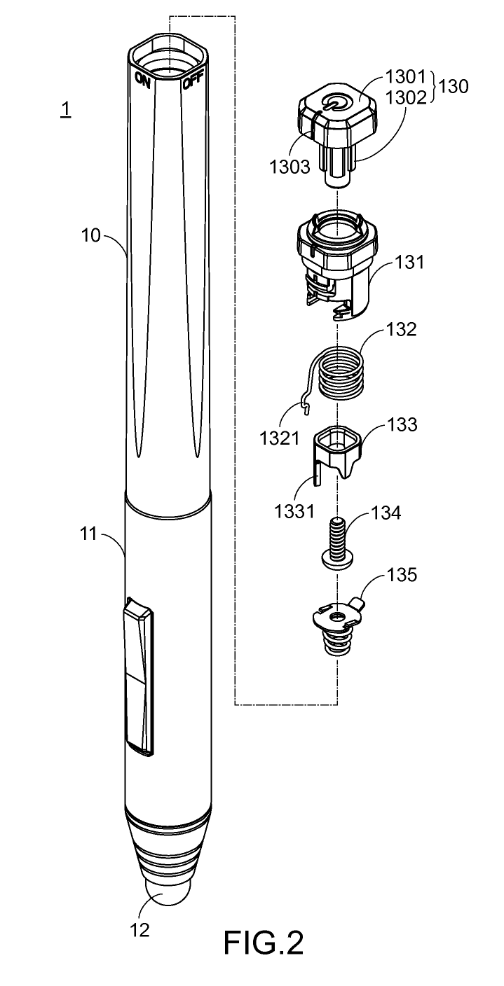

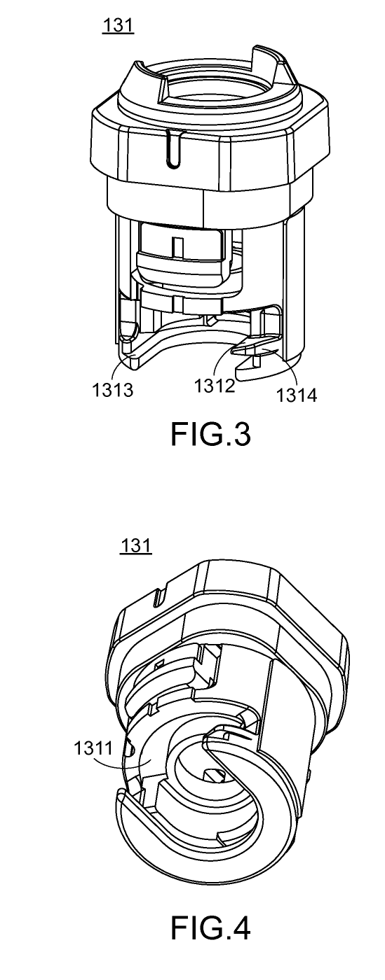

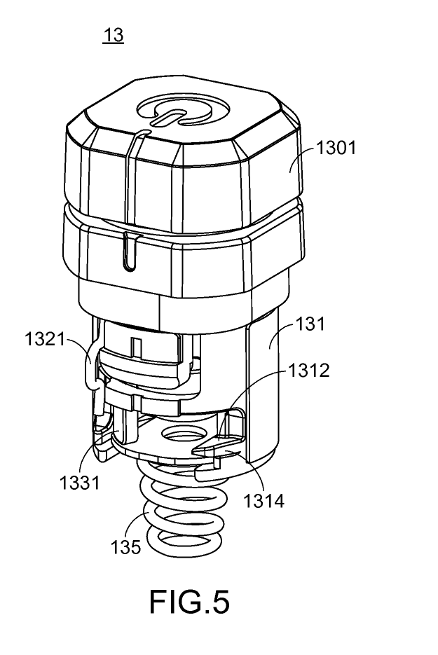

Hereinafter, a process of assembling the first pen tube 10 with the switch member 13 will be illustrated with reference to FIGS. 2-5. FIG. 2 is a schematic exploded view illustrating the switch member of the passive touch pen according to the first embodiment of the present invention. FIG. 3 is a schematic perspective view illustrating a hollow fixing post of the passive touch pen according to the first embodiment of the present invention and taken along a first viewpoint. FIG. 4 is a schematic perspective view illustrating the hollow fixing post of the passive touch pen according to the first embodiment of the present invention and taken along a second viewpoint. FIG. 5 is a schematic assembled view illustrating the switch member of the passive touch pen according to the first embodiment of the present invention.

As shown in FIG. 2, the switch member 13 comprises a rotary element 130, a hollow fixing post 131, a first conductive element 132, a second conductive element 133, a screw 134, and a negative electrode part 135. For example, the first conductive element 132 includes but is not limited to a metallic spring, the second conductive element 133 includes but is not limited to a metallic ring, and the negative electrode part 135 includes but is not limited to a spring or a resilience sheet. Moreover, the rotary element 130 comprises a rotating block 1301 and a pillar part 1302. The second conductive element 133 comprises a protrusion part 1331.

For assembling the switch member 13, the first conductive element 132 is firstly sheathed around the pillar part 1302. Moreover, the second conductive element 133 is also sheathed around the pillar part 1302 and contacted with the first conductive element 132. The pillar part 1302 is a non-circular structure. The shape of the second conductive element 133 matches the shape of the pillar part 1302. Consequently, the second conductive element 133 is not rotatable relative to the pillar part 1302.

Please refer to FIGS. 3 and 4. The hollow fixing post 131 comprises an elongated slot 1311, a raised block 1314 with a slant surface 1312, and a groove 1313. The raised block 1314 is disposed under the elongated slot 1311. The groove 1313 is disposed under the raised block 1314. As shown in FIGS. 2-5, the negative electrode part 135 is locked into the groove 1313; the pillar part 1302, the first conductive element 132 and the second conductive element 133 are penetrated through the hollow fixing post 131; and the protrusion part 1331 of the second conductive element 133 is penetrated through the elongated slot 1311 and contacted with the negative electrode part 135. Moreover, a first end 1321 of the first conductive element 132 is penetrated through the hollow fixing post 131 and exposed outside the hollow fixing post 131 (see FIG. 5).

Since the protrusion part 1331 is penetrated through the elongated slot 1311, the rotating angle of the second conductive element 133 is limited by the elongated slot 1311. In other words, the second conductive element 133 cannot be freely rotated. In some other embodiments, the hollow fixing post 131 is not equipped with the elongated slot 1311, wherein the second conductive element 133 is directly installed in the hollow fixing post 131 and freely rotatable relative to the hollow fixing post 131.

As shown in FIG. 2, the screw 134 is tightened into the pillar part 1302 of the rotary element 130 from bottom to top in order to prevent detachment of the rotary element 130, the first conductive element 132 and second conductive element 133 from the hollow fixing post 131. After the hollow fixing post 131 is inserted into and locked on the distal end 102 of the first pen tube 10, the switch member 13 and the first pen tube 10 are combined together. As mentioned above, the first end 1321 of the first conductive element 132 is penetrated through the hollow fixing post 131 and exposed outside the hollow fixing post 131. Consequently, after the hollow fixing post 131 is inserted into and locked on the distal end 102 of the first pen tube 10, the first end 1321 of the first conductive element 132 is connected with an inner wall of the first pen tube 10.

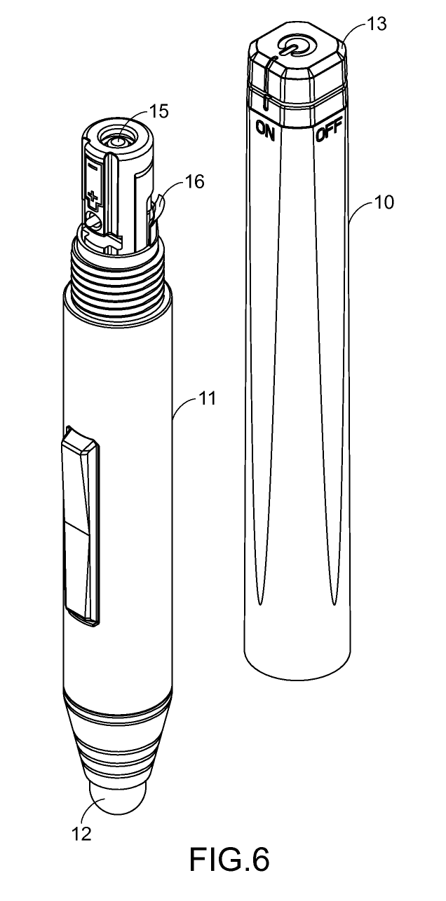

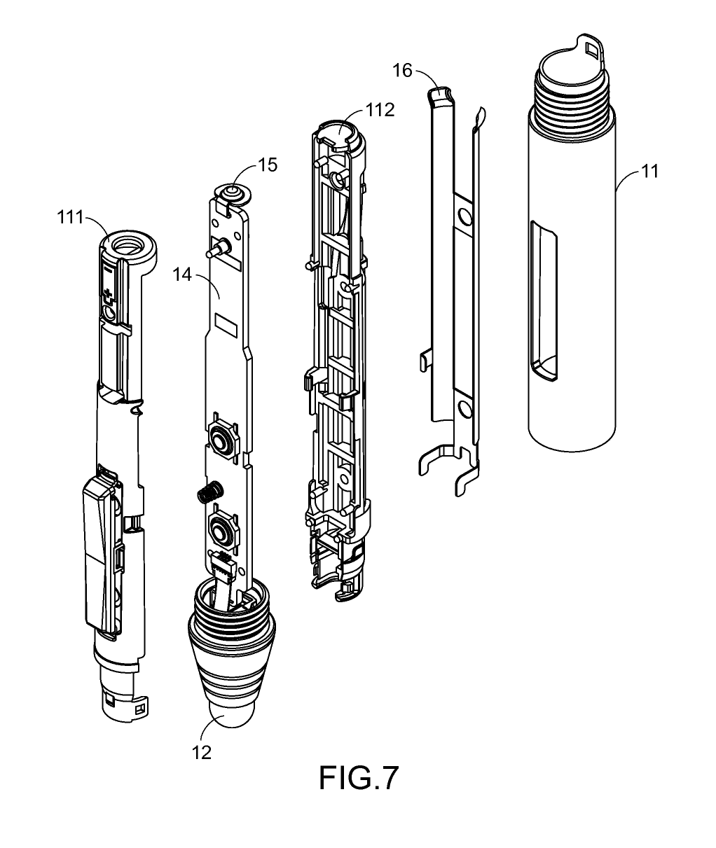

Hereinafter, the inner structure and the assembling sequence of the second pen tube 11 will be illustrated with reference to FIGS. 6 and 7. FIG. 6 is a schematic assembled view illustrating the combination of the second pen tube, a circuit board, a positive electrode part and a conductive plate of the passive touch pen according to the first embodiment of the present invention. FIG. 7 is a schematic exploded view illustrating the combination of the second pen tube, the circuit board, the positive electrode part and the conductive plate of the passive touch pen according to the first embodiment of the present invention.

As shown in FIG. 7, a circuit board 14, a positive electrode part 15 and a conductive plate 16 are disposed within the second pen tube 11. The circuit board 14 is clamped by a first case 111 and a second case 112 of the second pen tube 11, and thus fixed in the second pen tube 11. The positive electrode part 15 is disposed on a top end of the circuit board 14 and connected with a positive trace (not shown) of the circuit board 14. The conductive plate 16 is a metal plate. Moreover, the conductive plate 16 is located outside the second case 112 and connected with a negative trace (not shown) of the circuit board 14.

After the second pen tube 11, the circuit board 14, the positive electrode part 15 and the conductive plate 16 are combined together (see FIG. 6), the positive electrode part 15 and a portion of the conductive plate 16 are protruded outside the second pen tube 11. When the second pen tube 11 is connected with the front end 101 of the first pen tube 10, the positive electrode part 15 and the portion of the conductive plate 16 are inserted into the first pen tube 10, and the conductive plate 16 is contacted with the inner wall of the first pen tube 10.

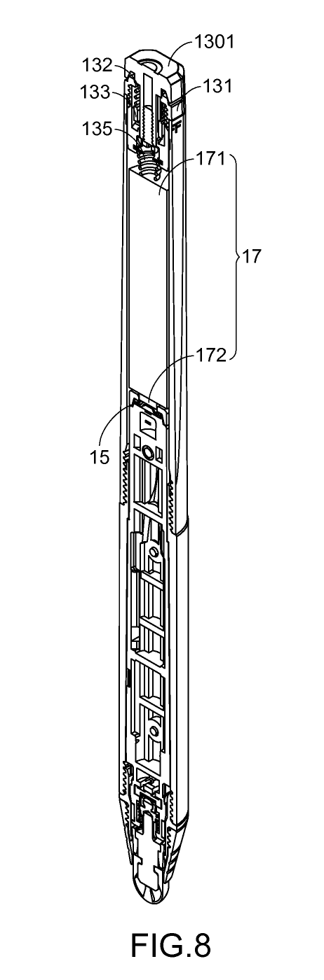

FIG. 8 is a schematic cutaway view illustrating the passive touch pen according to the first embodiment of the present invention. After the above assembling process is completed, a battery chamber is formed between the negative electrode part 135 and the positive electrode part 15. After a battery 17 is accommodated within the battery chamber, a negative terminal 171 and a positive terminal 172 of the battery 17 are contacted with the negative electrode part 135 and the positive electrode part 15, respectively. Under this circumstance, the additional functions of the passive touch pen 1 can be normally executed, which will be illustrated as follows.

Please refer to FIGS. 1-5. When the rotating block 1301 of the rotary element 130 exposed outside the first pen tube 10 is rotated in a clockwise direction to the position as shown in FIG. 1, a mark 1303 on the rotating block 1301 is aligned with a character “ON”. Under this circumstance, the protrusion part 1331 of the second conductive element 133 is located at the position as shown in FIG. 5 and contacted with the negative electrode part 135.

In this embodiment, the first pen tube 10 is made of a conductive material. Moreover, the conductive plate 16 is contacted with the first pen tube 10, and the first end 1321 of the first conductive element 132 is connected with the first pen tube 10. Consequently, when the protrusion part 1331 of the second conductive element 133 is contacted with the negative electrode part 135, a conductive loop is defined by the negative trace of the circuit board 14, the conductive plate 16, the first pen tube 10, the first conductive element 132, the second conductive element 133, the negative electrode part 135, the battery 17, the positive electrode part 15 and the positive trace of the circuit board 14 collaboratively. Under this circumstance, the circuit board 14 is powered by the battery 17.

After the circuit board 14 is powered by the battery 17, the electronic component on the circuit board 14 (e.g. a pressure sensor or an electronic switch) can be normally operated. Consequently, the additional function (e.g. the function of sensing the pen pressure) of the passive touch pen 1 can be executed.

When the rotating block 1301 of the rotary element 130 exposed outside the first pen tube 10 is rotated in a counterclockwise direction and the mark 1303 on the rotating block 1301 is aligned with a character “OFF”, the second conductive element 133 is correspondingly rotated with the pillar part 1302 of the first conductive element 132. Consequently, the protrusion part 1331 of the second conductive element 133 is moved upwardly along the slant surface 1312 of the raised block 1314. Meanwhile, the protrusion part 1331 is separated from the negative electrode part 135. That is, the negative trace of the circuit board 14, the conductive plate 16 contacted with the first pen tube 10, the first pen tube 10, the first conductive element 132 having the first end 1321 connected with the first pen tube 10, the second conductive element 133, the negative electrode part 135, the battery 17, the positive electrode part 15 and the positive trace of the circuit board 14 cannot form the conductive loop. Meanwhile, the circuit board 14 is no longer powered by the battery 17.

Alternatively, in some other embodiments, an insulation structure with a slant surface may be attached on the negative electrode part 135 in order to replace the raised block 1314 that has the slant surface 1312.

Moreover, when the second conductive element 133 is moved upwardly, the first conductive element 132 is pushed by the second conductive element 133, so that the first conductive element 132 is in a compressed state. Consequently, when the rotating block 1301 of the rotary element 130 exposed outside the first pen tube 10 is rotated in the clockwise direction again and the mark 1303 on the rotating block 1301 is aligned with the character “ON”, the first conductive element 132 is no longer influenced by the upward compressed force. Under this circumstance, the first conductive element 132 is restored to its original shape, and thus the second conductive element 133 is pushed downwardly by the first conductive element 132. Meanwhile, the protrusion part 1331 of the second conductive element 133 is contacted with the negative electrode part 135.

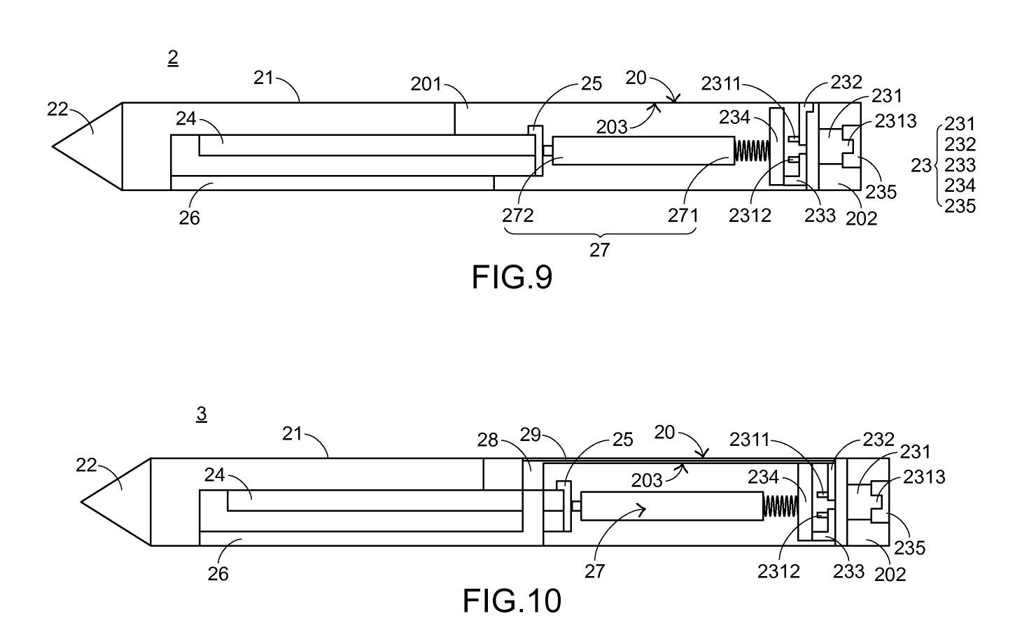

Hereinafter, a passive touch pen 2 according to a second embodiment of the present invention will be illustrated with reference to FIG. 9. FIG. 9 is a schematic cross-sectional view illustrating a passive touch pen according to a second embodiment of the present invention.

As shown in FIG. 9, the passive touch pen 2 of this embodiment comprises a first pen tube 20, a second pen tube 21, a conductive rubber tip 22, a switch member 23, a circuit board 24, a positive electrode part 25, a conductive plate 26, and a battery 27. The switch member 23 comprises a push switch 231, a first conductive element 232, a second conductive element 233, a negative electrode part 234, and a capping element 235. In this embodiment, the negative electrode part 234 includes but is not limited to a spring or a resilience sheet, the conductive plate 26 includes but is not limited to a metal plate, and the capping element 235 includes but is not limited to a plastic or rubbery element.

A process of assembling the passive touch pen 2 will be illustrated as follows. Firstly, two ends of the second pen tube 21 are connected with a front end 201 of the first pen tube 20 and the conductive rubber tip 22, respectively. The switch member 23 is located at a distal end 202 of the first pen tube 20. The circuit board 24 is disposed within the second pen tube 21. The positive electrode part 25 is connected with a positive trace of the circuit board 24. The conductive plate 26 is connected with a negative trace of the circuit board 24 and an inner wall 203 of the first pen tube 20. The battery 27 is accommodated within the first pen tube 20. A negative terminal 271 and a positive terminal 272 of the battery 27 are contacted with the negative electrode part 234 and the positive electrode part 25, respectively. In comparison with the first embodiment, the switch member 23 of this embodiment is distinguished. The structure of the switch member 23 will be illustrated in more details as follows.

The push switch 231 of the switch member 23 comprises a first pin 2311, a second pin 2312, and a triggering part 2313. The first conductive element 232 is connected with the inner wall 203 of the first pen tube 20 and the first pin 2311. The second conductive element 233 is connected with the second pin 2312. The negative electrode part 234 is connected with the second conductive element 233. The capping element 235 is connected with the triggering part 2313 of the push switch 231 and exposed outside the distal end 202 of the first pen tube 20.

In this embodiment, the first pen tube 20 is made of a conductive material (e.g. a metallic material). When the capping element 235 is pressed to push the triggering part 2313, the triggering part 2313 is moved to a pressed position. Consequently, the first pin 2311 and the second pin 2312 are electrically connected with each other. Meanwhile, a conductive loop is defined by the negative electrode part 234, the second conductive element 233, the second pin 2312, the first pin 2311, the first conductive element 232, the inner wall 203 of the first pen tube 20, the conductive plate 26, the negative trace of the circuit board 24, the battery 27, the positive electrode part 25 and the positive trace of the circuit board 24 collaboratively. Under this circumstance, the circuit board 24 is powered by the battery 27.

After the circuit board 24 is powered by the battery 27, the electronic component on the circuit board 24 (e.g. a pressure sensor or an electronic switch) can be normally operated. Consequently, the additional function (e.g. the function of sensing the pen pressure) of the passive touch pen 2 can be executed.

When the capping element 235 is pressed to push the triggering part 2313 again, the triggering part 2313 is returned to an original position. Meanwhile, the electrical connection between the first pin 2311 and the second pin 2312 is interrupted. Under this circumstance, the circuit board 24 is no longer powered by the battery 27.

Hereinafter, a passive touch pen 3 according to a third embodiment of the present invention will be illustrated with reference to FIG. 10. FIG. 10 is a schematic cross-sectional view illustrating a passive touch pen according to a third embodiment of the present invention.

As previously described in the second embodiment, the first conductive element 232 and the conductive plate 26 are connected with each other through the inner wall 203 of the first pen tube 20. That is, the inner wall 203 of the first pen tube 20 is a connecting element. In this embodiment, the first conductive element 232 and the conductive plate 26 are connected with each other through a connecting element 28. For example, the connecting element 28 is a flexible printed circuit board, an iron sheet or a conductive wire. Moreover, an insulating structure 29 is arranged between the connecting element 28 and the inner wall 203 of the first pen tube 20 in order to avoid a short-circuited problem.

The remaining configuration, the assembling process and the operating principle of the passive touch pen 3 of this embodiment are identical to those of the passive touch pen 2 of the second embodiment, and are not redundantly described herein.

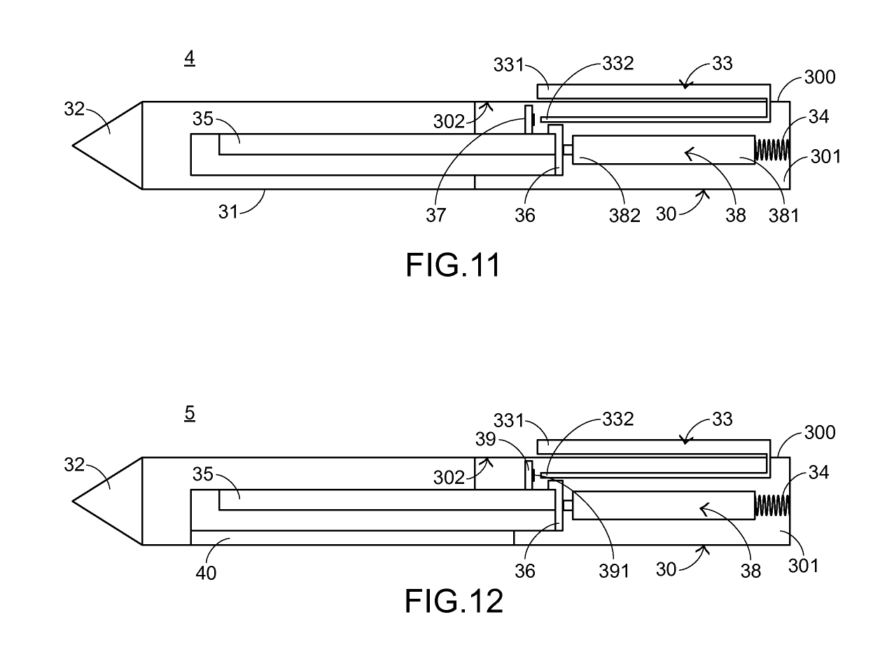

Hereinafter, a passive touch pen 4 according to a fourth embodiment of the present invention will be illustrated with reference to FIG. 11. FIG. 11 is a schematic cross-sectional view illustrating a passive touch pen according to a fourth embodiment of the present invention.

As shown in FIG. 11, the passive touch pen 4 of this embodiment comprises a first pen tube 30, a second pen tube 31, a conductive rubber tip 32, a pen clip 33, a negative electrode part 34, a circuit board 35, a positive electrode part 36, an elastic conductive element 37, and a battery 38. The pen clip 33 comprises a first end 331 and a second end 332, which are in parallel with each other. In this embodiment, each of the negative electrode part 34 and the elastic conductive element 37 includes but is not limited to a spring or a resilience sheet.

A process of assembling the passive touch pen 4 will be illustrated as follows. Firstly, two ends of the second pen tube 31 are connected with the first pen tube 30 and the conductive rubber tip 32, respectively. The first end 331 of the pen clip 33 is located outside of the first pen tube 30, and in parallel with a lateral surface 300 of the first pen tube 30. The second end 332 of the pen clip 33 is inserted into the first pen tube 30, and in parallel with the lateral surface 300 of the first pen tube 30. Then, the negative electrode part 34 is located at a distal end 301 of the first pen tube 30, and connected with an inner wall 302 of the first pen tube 30. Moreover, the circuit board 35 is disposed within the second pen tube 31, the positive electrode part 36 is connected with a positive trace of the circuit board 35, and the elastic conductive element 37 is connected with a negative trace of the circuit board 35. Moreover, the battery 38 is accommodated within the first pen tube 30. A negative terminal 381 and a positive terminal 382 of the battery 38 are contacted with the negative electrode part 34 and the positive electrode part 36, respectively.

While the first end 331 of the pen clip 33 is pushed by the user to be moved along the lateral surface 300 of the first pen tube 30 in a direction toward the conductive rubber tip 32, the second end 332 of the pen clip 33 is also moved along the lateral surface 300 of the first pen tube 30 to press the elastic conductive element 37. In this embodiment, the first pen tube 30 and the pen clip 33 are made of conductive materials. Consequently, a conductive loop is defined by the negative electrode part 34, the first pen tube 30, the pen clip 33, the elastic conductive element 37, the negative trace of the circuit board 35, the battery 38, the positive electrode part 36 and the positive trace of the circuit board 35 collaboratively. Under this circumstance, the circuit board 35 is powered by the battery 38.

After the circuit board 35 is powered by the battery 38, the electronic component on the circuit board 35 (e.g. a pressure sensor or an electronic switch) can be normally operated. Consequently, the additional function (e.g. the function of sensing the pen pressure) of the passive touch pen 4 can be executed.

While the first end 331 of the pen clip 33 is pushed by the user to be moved along the lateral surface 300 of the first pen tube 30 in a direction away from the conductive rubber tip 32, the second end 332 of the pen clip 33 is also moved along the lateral surface 300 of the first pen tube 30 in a direction away from the elastic conductive element 37. Under this circumstance, the circuit board 35 is no longer powered by the battery 38.

Hereinafter, a passive touch pen 5 according to a fifth embodiment of the present invention will be illustrated with reference to FIG. 12. FIG. 12 is a schematic cross-sectional view illustrating a passive touch pen according to a fifth embodiment of the present invention.

In this embodiment, a push switch 39 is used to replace the elastic conductive element 37 of the fourth embodiment. Moreover, the push switch 39 is connected with a positive trace of the circuit board 35 or an input/output pin of a processing unit. The passive touch pen 5 of this embodiment further comprises a conductive plate 40. The conductive plate 40 is connected with a negative trace of the circuit board 35 and the inner wall 302 of the first pen tube 30. Moreover, in this embodiment, the pen clip 33 does not need to be made of the conductive material.

While the first end 331 of the pen clip 33 is pushed by the user to be moved along the lateral surface 300 of the first pen tube 30 in a direction toward the conductive rubber tip 32, the second end 332 of the pen clip 33 is also moved along the lateral surface 300 of the first pen tube 30 to press a triggering part 391 of the push switch 39. Meanwhile, the triggering part 391 is moved to a pressed position. Consequently, the push switch 39 is turned on.

When the push switch 39 is connected with the positive trace of the circuit board 35 and the push switch 39 is turned on, the positive trace of the circuit board 35 is electrically conducted. Under this circumstance, a conductive loop is defined by the negative electrode part 34, the first pen tube 30, the conductive plate 40, the negative trace of the circuit board 35, the battery 38, the positive electrode part 36 and the positive trace of the circuit board 35 collaboratively. Under this circumstance, the circuit board 35 is powered by the battery 38.

In case that the push switch 39 is connected with the input/output pin of the processing unit, a corresponding signal is generated when the push switch 39 is turned on. After the signal is received by the processing unit, the electrical connection between the positive trace and the negative trace of the circuit board 35 is established by the processing unit. Consequently, the conductive loop is formed.

While the first end 331 of the pen clip 33 is pushed by the user to be moved along the lateral surface 300 of the first pen tube 30 in a direction toward the conductive rubber tip 32 again, the second end 332 of the pen clip 33 is also moved along the lateral surface 300 of the first pen tube 30 to press the triggering part 391 of the push switch 39 again. Consequently, the triggering part 391 is returned to an original position. Meanwhile, the push switch 39 is turned off. Under this circumstance, the circuit board 35 is no longer powered by the battery 38.

The remaining configuration, the assembling process and the operating principle of the passive touch pen 5 of this embodiment are identical to those of the passive touch pen 4 of the fourth embodiment, and are not redundantly described herein.

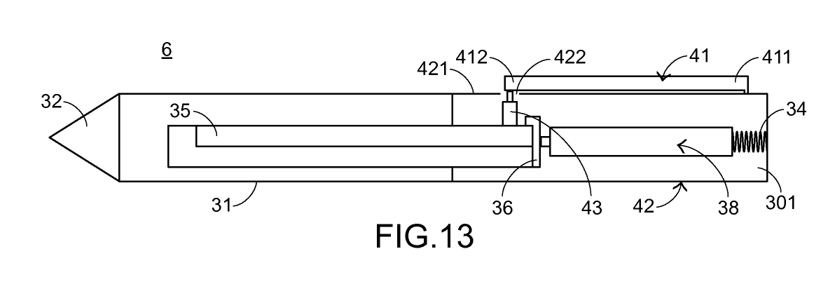

Hereinafter, a passive touch pen 6 according to a sixth embodiment of the present invention will be illustrated with reference to FIG. 13. FIG. 13 is a schematic cross-sectional view illustrating a passive touch pen according to a sixth embodiment of the present invention.

In comparison with the fourth embodiment, the following items are distinguished. In this embodiment, the pen clip 41 of the passive touch pen 6 is located outside of the first pen tube 42, and in parallel with a lateral surface 421 of the first pen tube 42. Moreover, a first end 411 of the pen clip 41 is fixed on the lateral surface 421 of the first pen tube 42, and a second end 412 of the pen clip 41 is separated from the first pen tube 42 by a specified distance. Moreover, an opening 422 is formed in the lateral surface 421 of the first pen tube 42. The elastic conductive element 43 is penetrated through the opening 422 and contacted with the second end 412 of the pen clip 41.

In this embodiment, the first pen tube 42 and the pen clip 41 are made of conductive materials. Consequently, when the elastic conductive element 43 is contacted with the second end 412 of the pen clip 41, a conductive loop is defined by the negative electrode part 34, the first pen tube 42, the pen clip 41, the elastic conductive element 43, the negative trace of the circuit board 35, the battery 38, the positive electrode part 36 and the positive trace of the circuit board 35 collaboratively. Under this circumstance, the circuit board 35 is powered by the battery 38.

When an object is placed between the first pen tube 42 and the pen clip 41, the elastic conductive element 43 is no longer contacted with the second end 412 of the pen clip 41. Under this circumstance, the circuit board 35 is no longer powered by the battery 38.

The remaining configuration, the assembling process and the operating principle of the passive touch pen 6 of this embodiment are identical to those of the passive touch pen 4 of the fourth embodiment, and are not redundantly described herein.

From the above descriptions, the present invention provides the passive touch pen. The switch member is located at a distal end of the first pen tube, or the pen clip is connected with the lateral surface of the first pen tube. Through the switch member or the pen clip, the circuit board can be powered by the battery. Consequently, if the additional function (e.g. the function of sensing the pen pressure) of the passive touch pen is not used, the electrical connection can be quickly interrupted. Since the electric power of the battery is not wasted, the power-saving efficacy is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A passive touch pen for a capacitive touch screen, the passive touch pen comprising:
a first pen tube made of a conductive material;
a second pen tube connected with a front end of the first pen tube;
a conductive rubber tip connected with the second pen tube;
a switch member located at a distal end of the first pen tube, wherein a function of providing electric power of a battery is selectively enabled or disabled through the switch member, wherein the switch member comprises:
a rotary element comprising a pillar part and a rotating block, wherein the pillar part is inserted into the first pen tube, and the rotating block is exposed outside the first pen tube;
a first conductive element sheathed around the pillar part and connected with an inner wall of the first pen tube;
a second conductive element sheathed around the pillar part and contacted with the first conductive element, and comprising a protrusion part; and
a negative electrode part fixed in the first pen tube and located near the protrusion part of the second conductive element, wherein while the rotating block is rotated, the second conductive element is correspondingly rotated with the pillar part, so that the protrusion part is contacted with or separated from the negative electrode part;
a circuit board disposed within the second pen tube;
a positive electrode part connected with a positive trace of the circuit board;
a conductive plate connected with a negative trace of the circuit board, and contacted with the inner wall of the first pen tube; and
the battery disposed within the first pen tube, wherein a negative terminal and a positive terminal of the battery are contacted with the negative electrode part and the positive electrode part, respectively,
wherein when the protrusion part of the second conductive element is contacted with the negative electrode part, a conductive loop is defined by the negative trace, the conductive plate, the first pen tube, the first conductive element, the second conductive element, the negative electrode part, the battery, the positive electrode part and the positive trace collaboratively, so that the battery provides the electric power to the circuit board.

2. The passive touch pen according to claim 1, wherein the switch member further comprises a hollow fixing post, wherein the hollow fixing post is inserted into the distal end of the first pen tube, wherein the pillar part, the first conductive element and the second conductive element are disposed within the hollow fixing post, and the negative electrode part is locked into the hollow fixing post.

3. The passive touch pen according to claim 2, wherein the hollow fixing post comprises an elongated slot, and the protrusion part of the second conductive element is penetrated through the elongated slot and limits an rotating angle of the second conductive element.

4. The passive touch pen according to claim 2, wherein the hollow fixing post comprises raised block with a slant surface, wherein the raised block is disposed under the elongated slot, wherein when the protrusion part of the second conductive element is moved along the slant, the protrusion part is separated from the negative electrode part.

5. The passive touch pen according to claim 1, further comprising an insulation structure with a slant surface, wherein the insulation structure is attached on the negative electrode part, wherein when the protrusion part of the second conductive element is moved along the slant, the protrusion part is separated from the negative electrode part.

6. The passive touch pen according to claim 1, wherein the first conductive element is a metallic spring that returns the second conductive element to an original position, the second conductive element is a metallic ring, the negative electrode part is a spring or a resilience sheet, and the conductive plate is a metal plate.

7. A passive touch pen for a capacitive touch screen, the passive touch pen comprising:
a first pen tube made of a conductive material;
a second pen tube connected with a front end of the first pen tube;
a conductive rubber tip connected with the second pen tube;
a switch member located at a distal end of the first pen tube, wherein a function of providing electric power of a battery is selectively enabled or disabled through the switch member, wherein the switch member comprises:
a push switch comprising a first pin, a second pin and a triggering part;
a first conductive element connected with the first pin;
a second conductive element connected with the second pin; and
a negative electrode part connected with the second conductive element;
a circuit board disposed within the second pen tube;
a positive electrode part connected with a positive trace of the circuit board;
a conductive plate connected with a negative trace of the circuit board;
a connecting element connected with the first conductive element and the conductive plate; and
the battery disposed within the first pen tube, wherein a negative terminal and a positive terminal of the battery are contacted with the negative electrode part and the positive electrode part, respectively,
wherein when the triggering part is pressed and the first pin and the second pin are electrically connected with each other, a conductive loop is defined by the negative electrode part, the second conductive element, the second pin, the first pin, the first conductive element, the connecting element, the conductive plate, the negative trace, the battery, the positive electrode part and the positive trace collaboratively, so that the battery provides the electric power to the circuit board.

8. The passive touch pen according to claim 7, wherein the connecting element is an inner wall of the first pen tube.

9. The passive touch pen according to claim 7, wherein the connecting element is a flexible printed circuit board, an iron sheet or a conductive wire, wherein an insulating structure is arranged between the connecting element and the inner wall of the first pen tube to avoid a short-circuited problem

10. The passive touch pen according to claim 7, wherein the negative electrode part is a spring or a resilience sheet, and the conductive plate is a metal plate.

11. The passive touch pen according to claim 7, wherein the switch member further comprises a capping element, wherein the capping element is connected with the triggering part and exposed outside the distal end of the first pen tube.

12. A passive touch pen for a capacitive touch screen, the passive touch pen comprising:
a first pen tube made of a conductive material;
a second pen tube connected with the first pen tube;
a conductive rubber tip connected with the second pen tube;
a pen clip connected with a lateral surface of the first pen tube, and comprising a first end and a second end, wherein the first end and the second end are in parallel with each other, the first end is exposed outside the first pen tube, and the second end is disposed within the first pen tube;
a negative electrode part disposed within the first pen tube, and connected with an inner wall of the first pen tube;
a circuit board disposed within the second pen tube;
a positive electrode part connected with a positive trace of the circuit board;
a conductive plate connected with a negative trace of the circuit board, and contacted with the inner wall of the first pen tube;
a push switch disposed on the circuit board, and comprising a triggering part, wherein a function of providing electric power of a battery is selectively enabled or disabled through the push switch; and
the battery disposed within the first pen tube, wherein a negative terminal and a positive terminal of the battery are contacted with the negative electrode part and the positive electrode part, respectively,
wherein when the first end of the pen clip is pushed and the pen clip is moved along the first pen tube, the push switch is pressed by the second end of the pen clip, so that the push switch is turned on, wherein after the push switch is turned on, a conductive loop is defined by the positive trace, the positive electrode part, the battery, the negative electrode part, the first pen tube, the conductive plate and the negative trace, so that the battery provides the electric power to the circuit board.

13. The passive touch pen according to claim 12, wherein the push switch is connected with the positive trace or an input/output pin of a processing unit.

14. A passive touch pen for a capacitive touch screen, the passive touch pen comprising:
a first pen tube made of a conductive material;
a second pen tube connected with the first pen tube;
a conductive rubber tip connected with the second pen tube;
a pen clip made of a conductive material, and connected with a lateral surface of the first pen tube;
a negative electrode part disposed within the first pen tube, and connected with an inner wall of the first pen tube;
a circuit board disposed within the second pen tube;
a positive electrode part connected with a positive trace of the circuit board;
an elastic conductive element connected with a negative trace of the circuit board, wherein a function of providing electric power of a battery is selectively enabled or disabled through the elastic conductive element; and
the battery disposed within the first pen tube, wherein a negative terminal and a positive terminal of the battery are contacted with the negative electrode part and the positive electrode part, respectively,
wherein when the elastic conductive element is connected with the pen clip, a conductive loop is defined by the negative electrode part, the first pen tube, the pen clip, the elastic conductive element, the negative trace, the battery, the positive electrode part and the positive trace collaboratively, so that the battery provides the electric power to the circuit board.

15. The passive touch pen according to claim 14, wherein the pen clip comprises a first end and a second end, wherein the first end and the second end are in parallel with each other, the first end is exposed outside the first pen tube, and the second end is disposed within the first pen tube, wherein when the first end of the pen clip is pushed and the pen clip is moved along the first pen tube, the elastic conductive element is pressed by the second end of the pen clip, so that the conductive loop is formed.

16. The passive touch pen according to claim 14, wherein a first end of the pen clip is fixed on the lateral surface of the first pen tube, and a second end of the pen clip is separated from the first pen tube by a specified distance, wherein the first pen tube has an opening, and the elastic conductive element is penetrated through the opening and contacted with the second end of the pen clip, so that the conductive loop is formed.
